(19) United States
(12) Patent Application Publication
(10) Pub. No.: US 2024/0195114 A1
(43) Pub. Date: Jun. 13, 2024

(54) ELECTRICAL CONNECTOR

(71) Applicant: Aptiv Technologies AG, Schaffhausen (CH)

(72) Inventors: Kamil FARON, Kraków (PL); Michal GRUDZEWSKI, Kraków (PL); Gert DROESBEKE, Erkrath (DE)

(21) Appl. No.: 18/536,640

(22) Filed: Dec. 12, 2023

(30) Foreign Application Priority Data
Dec. 12, 2022 (EP) 22212939.7

(51) Int. Cl. H01R 13/506

(52) U.S. Cl. CPC H01R 13/506

(57) ABSTRACT

An electrical connector includes a housing with a terminal module inserted in the housing in an axial direction, an electrical terminal fixed in the terminal module, a cover latched with the housing, and a spring that biases the terminal module in the axial direction.

### CROSS-REFERENCE TO RELATED APPLICATION

This application claims the benefit of and priority to European Patent Application No. 22212939.7, filed Dec. 12, 2022, the contents of which are incorporated by reference herein.

### TECHNICAL FIELD OF THE INVENTION

The present disclosure relates to an electrical connector such as a high-speed modular twisted-pair data connector used for automotive networking applications to support frequencies up to 20 GHZ and data transmission rates up to 56 Gbit/sec.

### BACKGROUND

An electrical signal travels as an electromagnetic field with a changing strength in time or in other words as a wave through space. When travelling through nonconductive and/or dielectric material instead of air, the electromagnetic wave will lose speed. The speed by which the signal can travel over a contact depends on the size of the conductors, the position of the conductors relative to each other, the amount and position of air between the conductors and the amount, position and type of dielectric material between the conductors.

The impedance of an interconnection channel quantifies the electrical field strength vs. magnetic field strength, based upon the influence of the above listed elements on the electromagnetic wave. For instance, more metal in the constitution of the channel will result in less impedance. Electromagnetic waves can hardly penetrate metal surfaces and are instead almost completely reflected at them. Hence, inside the metal, a 377 Ohm impedance of free space (i.e., no metals or dielectric parts present) drops to near zero.

For a two-wire system with signals having opposite phases such as high speed data connectors, this impedance is named differential mode impedance and has a target value of 100 Ohm. More important than this absolute impedance value is the variation along the interconnection channel. With each change in the impedance along the channel, proportional reflections of the signal will occur. The reflected portion of the signal causes at least a loss in signal amplitude, but when reflected again in the direction of the transmission it will be delayed and thus cause a false signal.

Within a connector system, like high speed data connectors, mechanical requirements also need to be observed, for instance adequate normal forces to absorb vibration between separable contact spheres, which demand a certain constitution of metal, dielectric and air which might result in a differential mode impedance not being 100 Ohm and/or not matched to neighboring sections causing signal reflections and losses.

It is the objective of the present disclosure to provide a connector with a terminal module, such as a high speed data module, which minimizes signal reflections and/or losses.

### SUMMARY

In one aspect, the present disclosure is directed at a connector that includes a housing with a terminal module inserted in the housing in an axial direction wherein an electrical terminal is fixed in the terminal module. A cover is latched with the housing and a spring is provided that biases the terminal module in the axial direction. Accordingly, when the connector is fully inserted in a mating connector such as a counter-connector or a header, the terminal module is urged in an axial direction to take an axial position relative to a terminal mating module of the mating connector. This minimizes a variation of the position of the electrical terminal of the terminal module with regard to an electrical terminal of the terminal mating module. As explained above, a high-speed signal transfer requires defined positions of signal conducting elements. In other words, the relative position of mating electrical terminals (male terminal and female terminal) will be defined to exclude a variation of an overlap between the male and the female electrical terminal and to ensure a defined position of the electrical terminal within the connector.

According to an embodiment, the spring is provided between the cover and the terminal module. When the cover is latched with the housing, the spring exerts a force in the axial direction onto the terminal module away from the cover and against a mating terminal module when the connector is fully plugged into a mating connector.

According to a further embodiment, the spring urges the terminal module towards the cover. Also, in this embodiment the spring contributes to ensure a defined axial position of the terminal module (and correspondingly of the electrical terminal fixed in the terminal module) after the connector has been plugged into a mating connector.

According to a further embodiment, the spring is integrally formed with the terminal module or with a cover, or respectively one spring is integrally formed with the terminal module and with the cover. Such designs facilitate the manufacturing process at low cost.

According to a further embodiment, the spring is formed as an arc-shaped web. The web may span an aperture formed within the terminal module or the cover.

According to a further embodiment, the spring has a Y-shaped cross-section. The two legs of the spring may be deflected when the spring is moved against an abutment.

According to a further embodiment, the spring is formed as a separate part. Thereby, it is possible to use spring materials that are adapted to the required spring forces. \According to a further embodiment, the terminal module has a biasing element that urges the electrical terminal in the axial direction against an abutment of the terminal module. Although the electrical terminals fixed in the terminal module have very little axial play, it may be advantageous to eliminate this play by means of the biasing element. The biasing element may be integrally formed with the terminal module as a region with increased resiliency to urge the electric terminal against an abutment of the terminal module. The biasing element could also have the form of a deformable web or a separate part, e.g., a metal spring inserted into the terminal module.

In another aspect, the present disclosure is directed at an assembly of a connector as disclosed above that is fully inserted and latched in a mating connector, wherein the spring urges the terminal module in the axial direction against an abutment of the mating connector.

According to an embodiment, the mating connector includes a terminal mating module inserted in a housing of the mating connector wherein an electrical terminal is fixed in the terminal mating module and wherein the abutment of the mating connector is provided on the terminal module of the mating connector. When both connectors are fully mated, the terminal module of the connector contacts the abutment of the mating connector. This eliminates clearances and ensures a defined axial position of both electrical terminals relative to each other.

In another aspect, the present disclosure is directed at a cable harness including a connector as disclosed above and/or including an assembly as disclosed.

### BRIEF DESCRIPTION OF THE DRAWINGS

The present invention is now described, by way of example with reference to the accompanying drawings, in which:

FIG. 1 is a perspective view of a connector that is fully inserted and latched in a mating connector according to an embodiment.

FIG. 2 as an illustration of a housing of the connector of FIG. 1 according to an embodiment.

FIG. 3 as an illustration of a terminal module of the type of high speed data module for two wire pairs according to an embodiment.

FIG. 4 as an illustration of a terminal module of the type of high speed data module for three wire pairs according to an embodiment.

FIG. 5 as an illustration of a cross-sectional view through the assembly of FIG. 1 according to an embodiment.

FIG. 6 as an illustration of an enlarged partial view of FIG. 5 according to an embodiment.

FIG. 7 is a perspective view of a cover according to an embodiment.

FIG. 8 is an enlarged detail of the cover of FIG. 7 according to an embodiment.

FIG. 9 is a side view of a terminal module of the type of high speed data module according to an embodiment.

### DETAILED DESCRIPTION

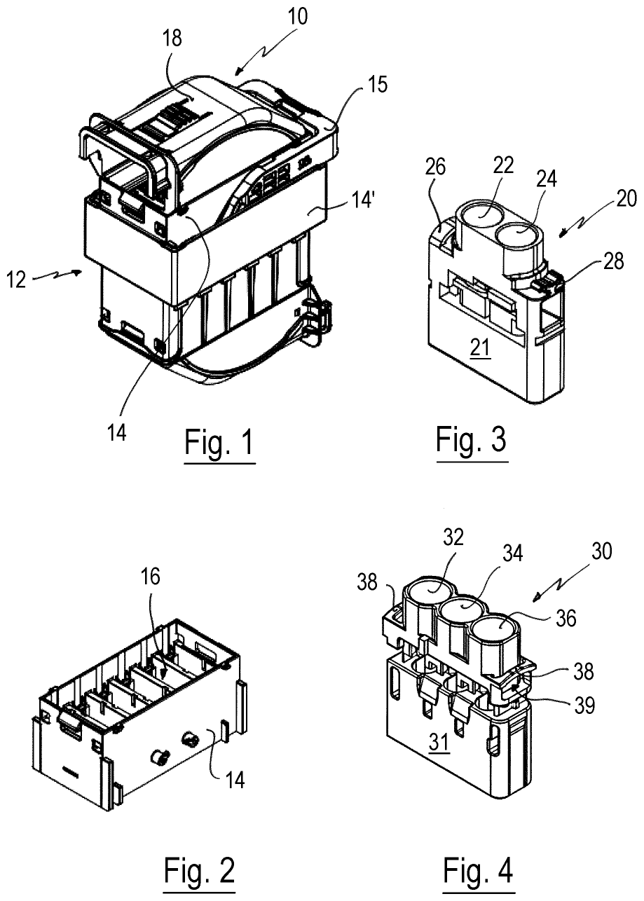

FIG. 1 depicts a perspective view of an assembly including a connector 10 that is fully inserted and latched in a mating connector 12. The connector 10 includes a housing 14 shown in FIG. 2 and the mating connector 12 includes a housing 14′. The housing 14 of the connector 10 includes a plurality of chambers 16 for respectively receiving a terminal module of the type of high speed data modules, such as shown in FIG. 3, 4 or 9. Each high speed data module includes one or more electrical terminals that are fixed in the high speed data module and connected to a wire. The high speed data modules are inserted in the chambers 16 of the housing 14 in an axial direction that is identical to the insertion direction of the connector 10 into the mating connector 12.

After the high speed data modules are inserted in the chambers 16 of the housing 14, a cover 18 is snapped onto the housing 14 thereby closing the housing 14 and latching the cover 18 with the housing 14.

FIG. 3 and FIG. 4 depict two different embodiments of a high speed data module. The high speed data module 20 shown in FIG. 3 includes a cuboidal main body 21 with receptacles for accommodating electrical terminals and with two openings 22 and 24 for inserting a wire pair that is connected at its free end to the electrical terminals.

As shown in FIG. 3, the high speed data module 20 includes respectively one spring 26 and 28. Both springs 26 and 28 are located at an upper surface of the main body 21 adjacent to the openings 22 and 24.

In the embodiment of FIG. 3 the spring 26 is integrally formed with the main body 21 of the high speed data module 20 and has the form of an arc-shaped web that spans an aperture formed in the high speed data module 20. The further spring 28 of the high speed data module 20 has a Y-shaped cross-section wherein two limbs of the Y are facing upwards, and a third limb of the Y is integrally connected to the main body 21.

An alternative embodiment of a high speed data module 30 with a cuboidal main body 31 is shown in FIG. 4. This embodiment is similar to the embodiment of FIG. 3 but includes three openings 32, 34 and 36 for inserting a wire pair that is connected to electrical terminals that are provided in the main body 31. The high speed data module 30 also includes at an upper side of the main body 31 respectively one spring 38 adjacent both outer openings 32 and 36 wherein both springs 38 have a design that is similar to the spring 26 of the high speed data module 20 of FIG. 3. The springs 38 are also integrally formed with the high speed data module 30 and have the form of an arc-shaped web spanning an aperture 39.

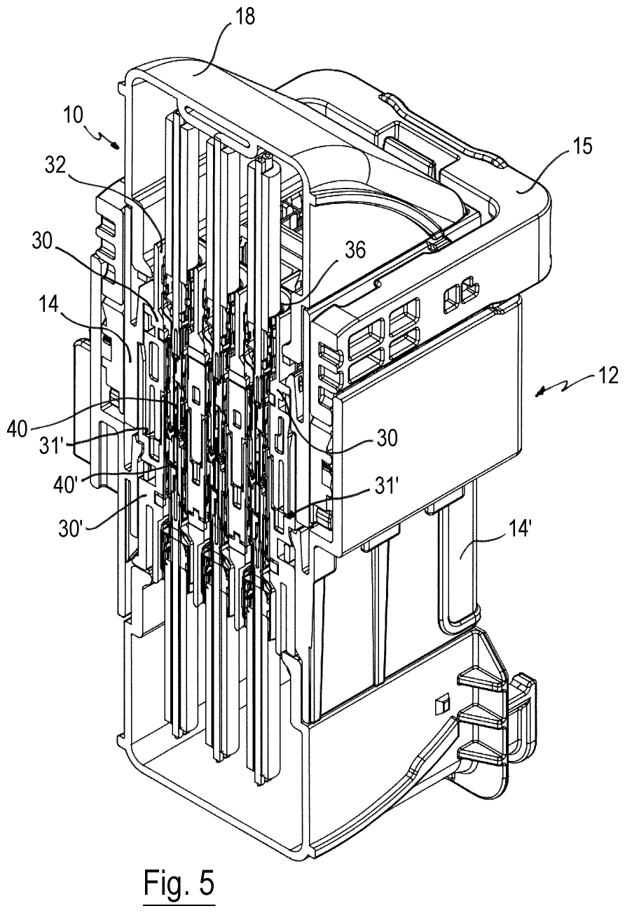

FIG. 5 shows a perspective cross-sectional view of the assembly of FIG. 1. The connector 10 is fully inserted into the mating connector 12 and latched by means of a traversable lever 15. For illustrative purposes, only one high speed data module 30 is shown that is inserted in a chamber 16 of the housing 14 with respectively one wire pair being inserted in each opening 32, 34 and 36. The free end of each wire is connected to an electrical terminal 40 that is fixed in the high speed data module 30.

As shown in FIG. 5, the mating connector 12 includes a high speed data mating module 30′ that has a similar design to the high speed data module 30 and accommodates mating electrical contacts 40)′.

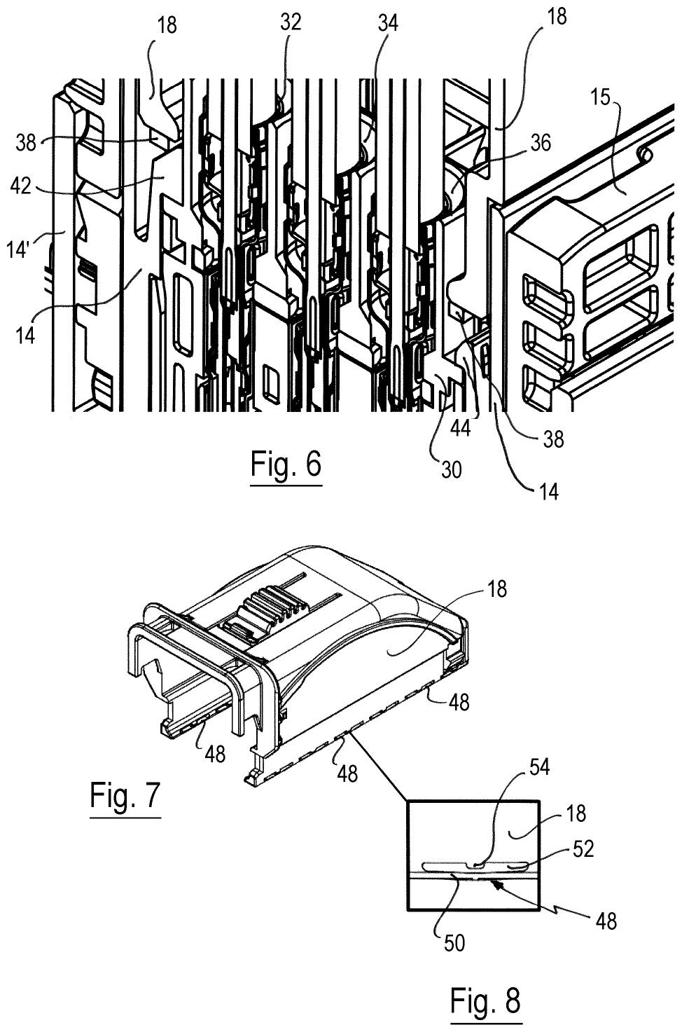

FIG. 6 depicts an enlarged partial view of FIG. 5 to illustrate that the high speed data module 30 is fixed in the housing 14 by means of hooks 42 and 44 that are integrally formed with the housing 14. However, in order to bias the high speed data module 30 in the axial direction towards the mating connector 12, the cover 18 contacts both springs 38 of the high speed data module 30 such that the springs 38 are compressed and bias the High Speed Data® module 30 away from the cover 18 and towards the mating connector 12.

According to a further embodiment shown in FIGS. 7 and 8 the High Speed Data® modules may be biased by means of a spring provided between the cover 18 and the high speed data module, wherein the spring is integrally formed with the cover 18. As shown in FIG. 7 and in particular the enlarged detail of FIG. 8 show, the cover 18 may be provided with a plurality of springs 48 integrally formed with the cover 18 and including a web 50 spanning an approximately rectangular opening 52 in the cover. Further, a protrusion 54 extends into the opening 52 opposite the web 50 serving as an abutment for the spring 50.

As shown in FIG. 7, the springs 48 are provided at the bottom side of the cover 18 along two parallel lower edges of the cover 18. These springs 48 can be used, alternatively or in addition to springs of the high speed data module, to bias the high speed data module in the axial direction. In all of the embodiments shown in the drawings, the springs are provided between the cover 18 and the high speed data module.

In the embodiments shown, the spring(s) that bias(es) the high speed data module of the connector 10 in the axial direction urge(s) the high speed data module 20, 30 of the connector 10 away from the cover 18 towards the mating-connector 12 until the high speed data module 30 contacts at its front end an abutment surface 31′ (FIG. 5) of the high speed data mating module 30′ to position and fix the high speed data module 20, 30 of the connector 10) in a defined position with regard to the mating high speed data module 30′.

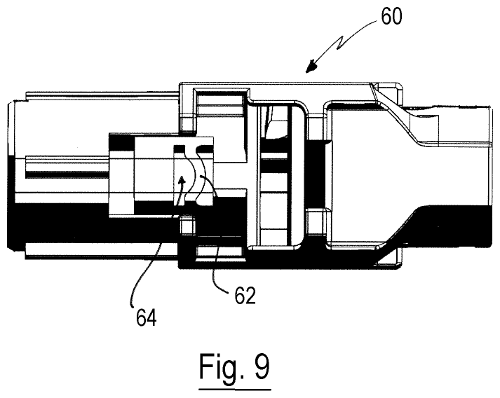

FIG. 9 shows a sideview of a further embodiment of a high speed data module 60. In this embodiment the high speed data module 60 is provided with a biasing element that urges an electrical terminal (not shown) inserted in the high speed data module 60 in the axial direction against an abutment of the high speed data module 60. In this embodiment, the biasing element is integrally formed with the high speed data module 60 and has the shape of an arc-shaped web 62 spanning an aperture 64. The biasing element 64 urges the electrical terminal in a fixed position having no play when the electrical terminal is finally mounted in the high speed data module 60, e.g., by means of a further element assuring the correct position of the terminal (TPA).

A biasing element as described above can be included in all embodiments of any high speed data module.

In some aspects, the techniques described herein relate to an electrical connector, including: a housing with a terminal module inserted in the housing in an axial direction, an electrical terminal fixed in the terminal module, a cover latched with the housing, and a spring that biases the terminal module in the axial direction.

In some aspects, the techniques described herein relate to an electrical connector, wherein the spring is provided between the cover and terminal module.

In some aspects, the techniques described herein relate to an electrical connector, wherein the spring is integrally formed with the terminal module and/or with the cover.

In some aspects, the techniques described herein relate to an electrical connector, wherein the spring is formed as an arc-shaped web.

In some aspects, the techniques described herein relate to an electrical connector, wherein the spring has a Y-shaped cross-section.

In some aspects, the techniques described herein relate to an electrical connector, wherein the spring is formed by a web spanning an aperture.

In some aspects, the techniques described herein relate to an electrical connector, wherein the spring urges the terminal module away from the cover.

In some aspects, the techniques described herein relate to an electrical connector, wherein the spring urges the terminal module towards the cover.

In some aspects, the techniques described herein relate to an electrical connector, wherein the spring is a separate part.

In some aspects, the techniques described herein relate to an electrical connector, wherein the terminal module has biasing element that urges the electrical terminal in the axial direction against an abutment of the terminal module.

In some aspects, the techniques described herein relate to a cable harness, including an electrical cable and a connector as described above.

In some aspects, the techniques described herein relate to an assembly, including: the electrical connector: and a mating connector, wherein the electrical connector is fully inserted and latched in the mating connector and wherein the spring urges the terminal module in the axial direction against an abutment of the mating connector.

In some aspects, the techniques described herein relate to an assembly, wherein a terminal mating module is inserted in a housing of the mating connector and an electrical terminal is fixed in the terminal mating module, wherein the abutment of the mating connector is provided on the terminal mating module of the mating connector.

In some aspects, the techniques described herein relate to a cable harness including: an electrical cable and an assembly as described above.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector, comprising:
a housing with a terminal module inserted in the housing in an axial direction:
an electrical terminal fixed in the terminal module;
a cover latched with the housing; and
a spring that biases the terminal module in the axial direction.

2. The electrical connector according to claim 1, wherein the spring is provided between the cover and the terminal module.

3. The electrical connector according to claim 1, wherein the spring is integrally formed with the terminal module and/or with the cover.

4. The electrical connector according to claim 1, wherein the spring is formed as an arc-shaped web.

5. The electrical connector according to claim 1, wherein the spring has a Y-shaped cross-section.

6. The electrical connector according to claim 1, wherein the spring is formed by a web spanning an aperture.

7. The electrical connector according to claim 1, wherein the spring urges the terminal module away from the cover.

8. The electrical connector according to claim 1, wherein the spring urges the terminal module towards the cover.

9. The electrical connector according to claim 1, wherein the spring is a separate part.

10. The electrical connector according to claim 1, wherein the terminal module has biasing element that urges the electrical terminal in the axial direction against an abutment of the terminal module.

11. A cable harness, comprising:
an electrical cable; and
a connector according to claim 1.

12. An assembly, comprising:
the electrical connector according to claim 1; and
a mating connector, wherein the electrical connector is fully inserted and latched in the mating connector and wherein the spring urges the terminal module in the axial direction against an abutment of the mating connector.

13. The assembly according to claim 12, wherein a terminal mating module is inserted in a housing of the mating connector and an electrical terminal is fixed in the terminal mating module, wherein the abutment of the mating connector is provided on the terminal mating module of the mating connector.

14. A cable harness, comprising:
an electrical cable; and
an assembly according to claim 12.
